(19) United States
(12) Patent Application Publication
(10) Pub. No.: US 2026/0025165 A1
(43) Pub. Date: Jan. 22, 2026

(54) COMMUNICATION SCHEDULING BASED ON CROSSTALK DATA

(71) Applicant: Groq, Inc., San Jose, CA (US)

(72) Inventors: Igor Arsovski, Williston, VT (US); Aleksey Tyshchenko, Vaughan (CA)

(21) Appl. No.: 19/276,560

(22) Filed: Jul. 22, 2025

Related U.S. Application Data
(60) Provisional application No. 63/674,071, filed on Jul. 22, 2024.

(51) Int. Cl. H04B 3/32; H04L 1/00

(52) U.S. Cl. CPC H04B 3/32; H04L 1/0001; H04L 1/0041

(57) ABSTRACT

An example method can include determining, by a compiler based at least in part on crosstalk data indicative of a rate of crosstalk between a first data transmission path and a second data transmission path, a timing of a first data transmission over the first data transmission path. The example method can include providing, by the compiler, one or more computer-readable instructions to cause one or more processor devices to initiate the first data transmission according to the timing.

### PRIORITY CLAIM

The present application claims priority to U.S. Provisional Application No. 63/674,071, filed Jul. 22, 2024, which is hereby incorporated by reference herein in its entirety.

### FIELD

The present disclosure relates generally to systems and methods for data transmission between computing devices or components thereof.

### BACKGROUND

Crosstalk is a phenomenon wherein a first signal transmitted via a first circuit or first communication channel may have an undesired effect on a second circuit or second communication channel. For example, in some instances, an electromagnetic field generated by a transmitting channel can induce a voltage in an adjacent channel, thereby causing interference and potentially leading to data transmission errors. In some instances, data transmission errors may cause various other problems, such as increased latency or reduced throughput of data transmission (e.g., due to a need to request retransmission of data that was not successfully transmitted, etc.).

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include determining, by a compiler based at least in part on crosstalk data indicative of a rate of crosstalk between a first data transmission path and a second data transmission path, a timing of a first data transmission over the first data transmission path. The example method can include providing, by the compiler, one or more computer-readable instructions to cause one or more processor devices to initiate the first data transmission according to the timing.

Example aspects of the present disclosure provide one or more example non-transitory computer-readable media storing instructions that are executable by one or more processors to cause a computing system to perform example operations. In some implementations, the example operations can include determining, by a compiler based at least in part on crosstalk data indicative of a rate of crosstalk between a first data transmission path and a second data transmission path, a timing of a first data transmission over the first data transmission path. The example operations can include determining, by the compiler, one or more computer-readable instructions to cause one or more processor devices to initiate the first data transmission according to the timing. The example operations can include outputting, by the compiler, the one or more computer-readable instructions.

Example aspects of the present disclosure provide an example computing system that includes one or more processors and one or more example non-transitory computer-readable media storing instructions that are executable by one or more processors to cause a computing system to perform example operations. In some implementations, the example operations can include determining, at a compile time based at least in part on crosstalk data indicative of a rate of crosstalk between a first data transmission path and a second data transmission path, a timing of a first data transmission over the first data transmission path. The example operations can include determining, at the compile time, one or more computer-readable instructions to cause one or more second processor devices to initiate the first data transmission according to the timing. The example operations can include providing the one or more computer-readable instructions to the one or more second processor devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example system for scheduling data transmission according to example implementations of aspects of the present disclosure;

FIG. 2A depicts a block diagram of an example first time step of a data transmission operation according to example implementations of aspects of the present disclosure;

FIG. 2B depicts a block diagram of an example second time step of a data transmission operation according to example implementations of aspects of the present disclosure;

FIG. 3 depicts a block diagram of an example system for compiling a machine-learned model to be executed by one or more processor devices according to example implementations of aspects of the present disclosure;

FIG. 4 depicts a block diagram of an example system for scheduling data transmission based on channel quality data according to example implementations of aspects of the present disclosure;

FIG. 5A depicts a block diagram of a first example pair of adjacent communication channels according to example implementations of aspects of the present disclosure;

FIG. 5B depicts a block diagram of a second example pair of adjacent communication channels according to example implementations of aspects of the present disclosure;

FIG. 5C depicts a block diagram of a third example pair of adjacent communication channels according to example implementations of aspects of the present disclosure;

FIG. 5D depicts a block diagram of fourth and fifth example pairs of adjacent communication channels according to example implementations of aspects of the present disclosure;

FIG. 6 is a block diagram of an example processor device according to example implementations of aspects of the present disclosure; and

FIG. 7 is a block diagram of an example system for compiling a machine-learned model according to example implementations of aspects of the present disclosure.

### DETAILED DESCRIPTION

Example embodiments according to some aspects of the present disclosure are directed to systems and methods for scheduling a timing of data transmissions (e.g., chip-to-chip communications in a multiprocessor computing system, etc.) to mitigate an effect of cross-talk. In some instances, the timing can be determined at compile time. For example, a compiler can obtain crosstalk data indicative of a rate of crosstalk between various pairs of communication channels in a computing system, and the compiler can schedule a timing of data transmissions over the communication channels based at least in part on the crosstalk data. For example, in some instances, the compiler can mitigate crosstalk by avoiding simultaneous transmission over adjacent communication channels that have a high rate of crosstalk between the adjacent channels.

Crosstalk data can include, for example, data indicative of various factors that can affect a strength of crosstalk between two communication channels, such as a metric of distance between the two communication channels, a strength of each signal being transmitted over the communication channels, a length of each communication channel, or other crosstalk data. For example, pairs of transmission paths that are close together at one or more points along each transmission path (e.g., at a transmitter, receiver, or connector along each path, etc.) can have high rates of crosstalk in some instances. As another example, in some instances, a high-power data transmission signal may cause more crosstalk on an adjacent communication channel compared to a low-power signal, while a low-strength signal may be more vulnerable to interference from adjacent signals. As another example, in some instances, a signal sent over a long data transmission path may suffer a greater transmission loss than a signal sent over a short data transmission path, which can increase a risk of crosstalk associated with the long data transmission path.

In some instances, avoiding simultaneous transmission over high-crosstalk pairs of data transmission paths can include selecting a defined time (e.g., defined clock cycle, etc.) to transmit data along a given path; selecting a path to transmit data at a given time; or both. For example, in some instances, a compiler may identify a particular time at which data must arrive at a destination (e.g., a processor device receiving the data), and the compiler may select, based at least in part on crosstalk data, a data transmission path to transmit the data at that time. As another example, in some instances, a compiler may identify a set of one or more candidate data transmission paths for transmitting data from a given source to a given destination, and the compiler may select, based at least in part on crosstalk data, a time to transmit the data over one or more of the candidate data transmission paths.

In some instances, a computing system can monitor quality data (e.g., transmission error rate data, signal-to-noise ratio data, etc.) for one or more data transmission paths, and can adjust based at least in part on the quality data. For example, in some instances, a computing system can determine, based on the quality data, that one or more data transmission paths have an error rate or crosstalk rate that is above a threshold (e.g., above an expected error rate, above a maximum acceptable error rate, etc.) or other channel quality value that is worse than a channel quality threshold. Continuing the example, in some instances, the computing system can, responsive to determining that the channel quality is worse than the channel quality threshold, reschedule or reroute one or more data transmissions to reduce an amount of crosstalk associated with the data transmission(s). For example, in some instances a computing system can reschedule data transmission(s) to increase a number of channel(s) that must be idle when a particular communication channel is active; to increase an amount of time that each adjacent channel should be idle before or after the particular communication channel is active; or provide other crosstalk-reducing instructions indicative of a revised schedule that provides a greater reduction in crosstalk compared to a first schedule. As another example, in some instances, a computing system can determine, based on quality data, that an error rate or crosstalk rate is lower than a threshold (e.g., unexpectedly low, at a level that can be corrected using a forward error correction algorithm, etc.), and can reschedule based on the quality data to increase a rate of simultaneous transmission (e.g., to increase an overall data transmission throughput) or otherwise provide throughput-increasing instructions indicative of a revised schedule.

In some instances, example data transmission paths that can be scheduled according to aspects of the present disclosure can include chip-to-chip communication paths, such as chip-to-chip communication paths that may use a serializer-deserializer mechanism. A serializer-deserializer mechanism can include, for example, serializing data at a transmitting processor device; sending the serialized data over a serial communication link; and deserializing the data at a receiving processor device. In some instances, data sent over a serialized communication link can further include additional data, such as clock data, synchronization data, one or more error correction bits, or the like.

In some instances, data transmission operations can be performed by one or more deterministic processor devices, such as processor devices configured to perform one or more operations (e.g., data transmission operations, matrix operations, arithmetic operations, etc.) in a program order defined by a compiler at compile time. For example, in some instances, a deterministic processor device can include a processor configured to perform operations (e.g., data transmission operations, all processor operations, etc.) at a defined time instant (e.g., defined clock cycle, etc.) determined by the compiler at compile time. In some instances, a deterministic processor can include a processor that may be configured to operate without using one or more nondeterministic optimizations, such as without using branch prediction or speculative execution; without using a cache hierarchy; without speculatively prefetching data; or the like.

Example embodiments according to some aspects of the present disclosure can provide for a number of technical effects and benefits, such as improvements to computing technology (e.g., chip-to-chip communication technology, machine learning technology, etc.). For example, in some instances, systems and methods according to some aspects of the present disclosure can reduce an amount of crosstalk associated with chip-to-chip communication compared to some alternative implementations. In some instances, reducing an amount of crosstalk can provide a reduced error rate for a given set of computational parameters (e.g., given transmission power, given error correction algorithm, etc.). In some instances, a reduced error rate can reduce a rate of retransmission, thereby reducing a communication cost (e.g., electricity cost, number of bits transmitted, latency cost, etc.) of transmitting a given amount of data.

Additionally or alternatively, in some instances, reducing an amount of crosstalk can enable transmission of data at a given error rate at reduced computational cost compared to some alternative implementations. For example, in some instances, reducing an effect of crosstalk can enable transmission at a reduced transmission power, thereby reducing a cost (e.g., electricity cost, etc.) of transmitting data at a given error rate. As another example, in some instances, reducing an effect of crosstalk can enable the use of a lower-cost or lower-complexity error correction algorithm (e.g., fewer error correction bits, reduced computational complexity, etc.), thereby reducing a cost (e.g., communication cost in bits, computational cost, etc.) of transmitting data at a given error rate.

With reference now to the Figures, example embodiments of the present disclosure will be discussed in further detail.

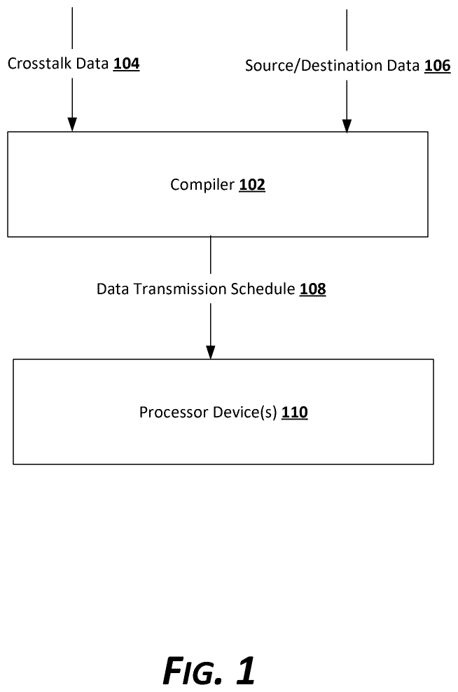

FIG. 1 depicts a block diagram of an example system for scheduling data transmission according to example implementations of aspects of the present disclosure. A compiler 102 can obtain (e.g., receive, retrieve, generate, etc.) crosstalk data 104 indicative of an amount of crosstalk between one or more pairs of communication channels. The compiler 102 can further obtain source/destination data 106 indicative of one or more data transmission operations to be performed. Based on the crosstalk data 104 and source/destination data 106, the compiler 102 can determine a data transmission schedule 108 defining a timing of one or more data transmission operations along one or more data transmission paths. The compiler 102 can directly or indirectly provide data (e.g., computer-executable instructions, etc.) indicative of the data transmission schedule 108 to one or more processor devices 110 (e.g., by outputting a compiled program to be provided to the processor device(s) 110 by another process or component, etc.), and the processor device(s) 110 can perform one or more data transmission operations according to the data transmission schedule 108.

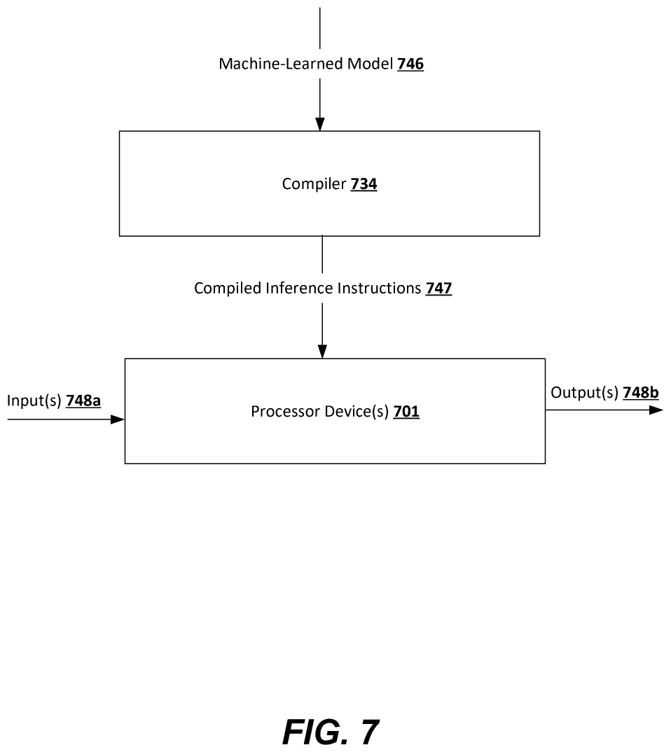

A compiler 102 can be or include one or more software, firmware, or hardware components configured to generate one or more computer-executable instructions (e.g., object code, assembly code, machine code, bytecode, etc.) based on input data associated with the one or more computer-executable instructions (e.g., source code data, machine-learned model parameter data, etc.). For example, in some instances, a compiler can include one or more components configured to obtain first data indicative of one or more computing operations (e.g., source code data, machine-learned model parameter data, etc.), and generate, based on the first data, one or more computer-executable instructions to cause one or more processor devices to perform the one or more computing operations. In some instances, the compiler 102 can be, comprise, be comprised by, or share one or more properties with one or more compilers described below with respect to FIG. 7 (e.g., compiler 734, etc.).

Crosstalk data 104 can include or represent various data types. Crosstalk data 104 can include one data type or multiple data types. Example data types for crosstalk data 104 can include, for example, numerical data (e.g., numerical distance data, error rate data, signal-to-noise-ratio data, etc.), Boolean data, or other data type.

In some instances, crosstalk data 104 can include any data indicative of crosstalk between groups (e.g., pairs) of data transmission paths, such as experimental data indicative of a measured crosstalk amount, proxy data indicative of an estimated crosstalk amount or otherwise correlated with an amount of crosstalk, or other data indicative of crosstalk. In some instances, crosstalk data 104 can include data indicative of a proximity between pairs of data transmission paths, such as numerical data indicative of a physical distance between one or more parts of a first data transmission path and one or more parts of a second data transmission path; Boolean data indicating that a first and second data transmission path are proximate or not proximate to each other (e.g., are or are not located on a same edge of a hardware device such as a processor device; are or are not in close proximity inside a package; are or are not closer together than a distance threshold; etc.); or other proximity data. In some instances, proximity data can include data indicative of a distance between a first component of a first data transmission path and a second component associated with a second data transmission path, wherein the first component can be any one of: a transmitting component, a receiving component, a connecting component, or another component type; and wherein the second component can be any one of: a transmitting component, a receiving component, a connecting component, or another components type, irrespective of a component type of the first component.

In some instances, crosstalk data 104 can include individual-path data associated with one or more individual transmission paths, such as data indicative of a vulnerability to crosstalk at one or more points along the individual transmission path(s); data indicative of a signal strength required to transmit a signal along an individual transmission path, or indicative of an expected signal strength at each of one or more points along an individual transmission path; data indicative of an amount of transmission loss along the individual transmission path between one or more components (e.g., transmitter, receiver, connector(s), etc.) of the individual transmission path; or the like. For example, in some instances, sending a signal along a long transmission path or a transmission path with high transmission loss may require transmitting a stronger signal from a transmitter compared to some lower-transmission-loss paths, or may require receiving a weaker signal at a receiver compared to some lower-transmission-loss paths. In such instances, a stronger signal sent from a transmitting component (e.g., chip-to-chip communication port, etc.) of the high-loss transmission path may cause greater crosstalk in data transmission path(s) that are proximate to (e.g., adjacent to, etc.) the transmitting component. Similarly, in some instances, a weaker signal received at a receiving component of a high-loss transmission path may be more vulnerable to crosstalk from data transmission path(s) that are proximate to (e.g., adjacent to, etc.) the transmitting component. For example, a lower-strength signal may suffer a greater loss in signal-to-noise ratio or a greater increase in error rate from a given amount of crosstalk compared to higher-strength signals. In some instances, crosstalk data 104 can include other data indicative of crosstalk, such as impedance data indicative of one or more of a transmission line impedance, receiver impedance, difference metric indicative of a line-receiver impedance mismatch; vulnerability data indicative of an effect of crosstalk on an error rate (e.g., due to signal strength, data pattern scrambling, or other factor); or other crosstalk data.

In some instances, crosstalk data 104 can include data indicative of whether an amount of crosstalk between a first data transmission path and one or more second data transmission paths exceeds one or more predetermined thresholds. For example, in some instances, crosstalk data 104 can include data (e.g., Boolean data, etc.) indicating whether one or more proximity metrics (e.g., proximity between first transmitter and second transmitter; proximity between receiver and second receiver; proximity between first transmitter and second receiver; or other proximity metric) exceeds a proximity threshold. In some instances, a proximity threshold can include a predetermined fixed threshold, or an adaptive threshold. In some instances, an adaptive proximity threshold can be based on one or more factors, such as an estimated signal strength of one or more signals to be sent along each of a first and second data transmission path; a component type of each of a first and second component associated with the proximity data; or other relevant factors. As a non-limiting illustrative example, a close proximity between signal traces in a cable or on a board may have less impact on an amount of crosstalk than a similarly close proximity between a first transmitter and a second transmitter on the same edge of a die, or between transmitter and receiver, or close proximity at a connector coupling, or close proximity inside a package. Continuing the illustrative example, an adaptive proximity threshold may include data comparing a distance between two transmitters to a first distance threshold, and may include data comparing a distance between two signal traces on a board to a second distance threshold that is smaller than the first distance threshold. Other examples are possible.

In some instances, an adaptive proximity threshold can be based at least in part on error rate data or noise data, such as data indicative of an amount of noise or error rate from non-crosstalk error sources that a data transmission path may be subjected to; a minimum signal-to-noise ratio or maximum acceptable error rate associated with an error correction algorithm, latency target, or the like; or other error or noise data. For example, in some instances, an adaptive proximity threshold or adaptive error/noise threshold can include a threshold determined by identifying a plurality of noise sources; and identifying a proximity threshold to cause a total amount of noise from the plurality of noise sources to be below a noise threshold or error rate threshold.

In some instances, crosstalk data 104 can include data (e.g., numerical data, etc.) indicative of an expected impact of crosstalk on one or more signals to be sent along one or more data transmission paths, such as an expected change in signal-to-noise ratio caused by such crosstalk; an expected change in bit error rate or other error rate data (e.g., retransmission rate associated with errors that cannot be corrected with forward error correction, etc.); an expected absolute signal-to-noise ratio or absolute bit error rate data based on an expected amount of crosstalk and one or more other expected error sources or noise sources; or other data indicative of an expected impact of crosstalk.

In some instances, crosstalk data 104 can include score data, such as weighted score data comprising a weighted combination of one or more other crosstalk data 104 values (e.g., weighted combination of proximity values, signal strength values, etc.). For example, in some instances, a weighted combination can include a sum of a plurality of impact values indicative of an estimated impact (e.g., on signal-to-noise ratio, on bit error rate, etc.) of crosstalk from a plurality of crosstalk sources. For example, in some instances, crosstalk data 104 can include data indicative of an expected total impact of crosstalk on a first signal sent along a first data transmission path according to a first candidate data transmission schedule 108. Continuing the example, data indicative of an expected total impact of crosstalk on the first signal can include a sum of pairwise crosstalk values associated with a plurality of second data transmission paths scheduled to be active when the first signal is scheduled to be sent according to the first candidate data transmission schedule 108. Other examples are possible.

In some instances, crosstalk data 104 can include data obtained in any manner by the compiler 102, such as data retrieved or received from another computing component or from a hardware device (e.g., memory, file system, processor device, computing device, network or other communication interface, etc.), or data generated by the compiler 102 or a computing device associated with the compiler 102. For example, in some instances, a compiler 102 can generate, based on first crosstalk data 104 (e.g., experimental crosstalk data 104; hardware schematic data; proximity data; transmission path length data or transmission loss data; etc.), one or more second crosstalk data 104 items (e.g., weighted score data, estimated error rate or signal-to-noise ratio data, Boolean data indicative of a comparison between the first crosstalk data 104 and one or more proximity thresholds or crosstalk thresholds, etc.).

In some instances, crosstalk data 104 can include crosstalk data 104 associated with one or more fixed data transmission paths (e.g., hard-wired paths, etc.) or reconfigurable data transmission paths (e.g., paths comprising one or more switches, patch panels, or the like; multi-leg paths comprising one or more routers or connectors; etc.).

Source/destination data 106 can include or represent various data types. Source/destination data 106 can include one data type or multiple data types, which can be similar to (e.g., same as) or different from one or more data types of crosstalk data 104. Example data types for source/destination data 106 can include, for example, numerical data (e.g., numerical identifier or transmitter or receiver device, numerical memory address or vector index of data to be transmitted, numerical message size data, etc.), text data (e.g., variable name data, etc.), identifier data, binary data, or other data type.

Source/destination data 106 can include data indicative of one or more data transfer operations. For example, in some instances, source/destination data 106 can include, for each of one or more data transfer operations, data indicative of a source device or component from which data should be sent (e.g., device identifier, device address or location, etc.); data indicative of a destination device or component to which data should be sent (e.g., device identifier, device address or location, etc.); data indicative of the data to be sent (e.g., memory address, filename, variable name, etc.); or data indicative of other relevant values, such as a size (e.g., size in bytes, etc.) of the data to be sent. In some instances, a source and a destination can include a source-destination pair having only one data transmission path between source and destination or multiple data transmission paths between source and destination.

In some instances, source/destination data 106 can include low-level data prescribing particular data transfer operations, or can include high-level data indicative of a plurality of computing operations (e.g., machine learning operations, data processing operations such as matrix multiplication operations, etc.), wherein the compiler 102 can determine one or more lower-level data transfer operations for performing the plurality of computing operations. As a non-limiting illustrative example, in some instances, the compiler 102 can obtain first source/destination data 106 (e.g., source code, etc.) indicative of a set of computing operations to be performed by a plurality of processors; partition the set of computing operations and allocate the partitions to the plurality of processors; and determine second source/destination data 106 indicative of one or more data transfer operations that must be performed to implement the set of computing operations according to the partitioning. In some instances, partitioning a set of computing operations or determining a set of data transfer operations (e.g., set of source-destination-data tuples, etc.) can be based at least in part on crosstalk data 104, or can be performed without reference to crosstalk data 104.

In some instances, determining a data transmission schedule 108 based on source/destination data 106 can include obtaining (e.g., receiving, retrieving, generating, etc.) first source/destination data 106 describing a plurality of computing operations at a high level, such as high-level description data that may not identify specific data transmission paths; may not include partition data indicating which processor devices perform which operations; may not specify low-level data transfer operations between specific source and destination processors; or the like. In such instances, determining a data transmission schedule 108 can include determining second source/destination data 106 based on the first source/destination data 106. For example, in some instances, a compiler 102 can obtain source code data indicative of a plurality of operations; and can determine, based at least in part on the source code data and based at least in part on crosstalk data 104, one or more partitions dividing the plurality of operations among a plurality of processors. For example, in some instances, determining a partition based on crosstalk data 104 can include identifying a plurality of candidate partitions; generating a candidate data transmission schedule 108 for each of the plurality of candidate partitions; and selecting between the candidate partitions based at least in part on one or more of crosstalk data 104 and the candidate data transmission schedule(s) 108. As another example, in some instances, determining a partition based on crosstalk data 104 can include determining the partition based on one or more heuristics, such as determining or estimating an amount of data to be transferred between identified pairs of processors for a candidate partition, and selecting a partition that reduces (e.g., minimizes, nearly minimizes, etc.) one or more data transfer amounts (e.g., sum of data amounts expected to be transferred on adjacent paths; sum of data amounts having adjacent shortest available paths; etc.).

A data transmission schedule 108 can include or represent various data types. A data transmission schedule 108 can include one data type or multiple data types, which can be similar to (e.g., same as) or different from one or more data types of crosstalk data 104 or source/destination data 106. Example data types for a data transmission schedule 108 can include date, time, or timestamp data; numerical data (e.g., numerical data of sender, receiver, or data to be sent; numerical timing data; etc.); or other data type (e.g., text, binary, etc.).

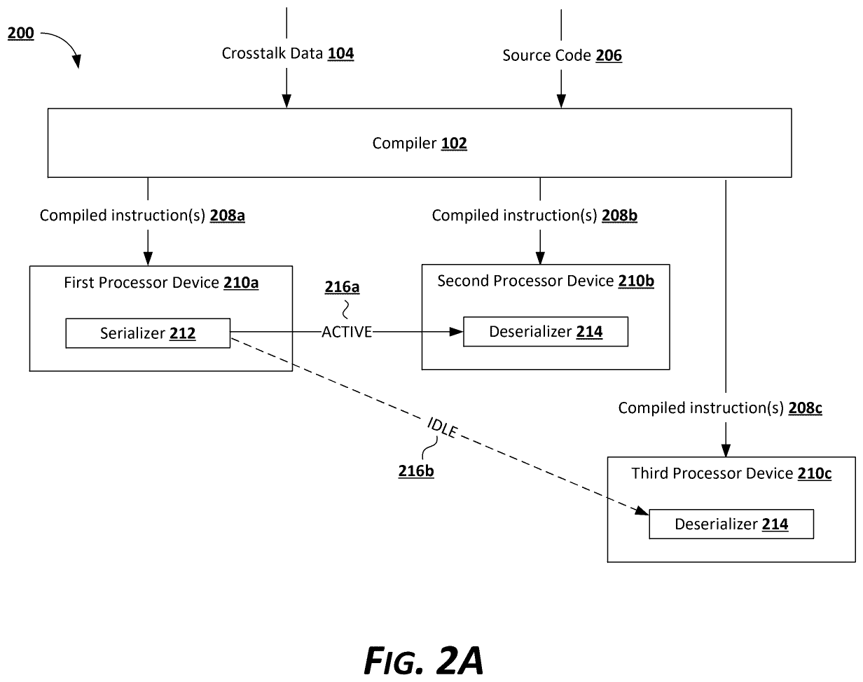

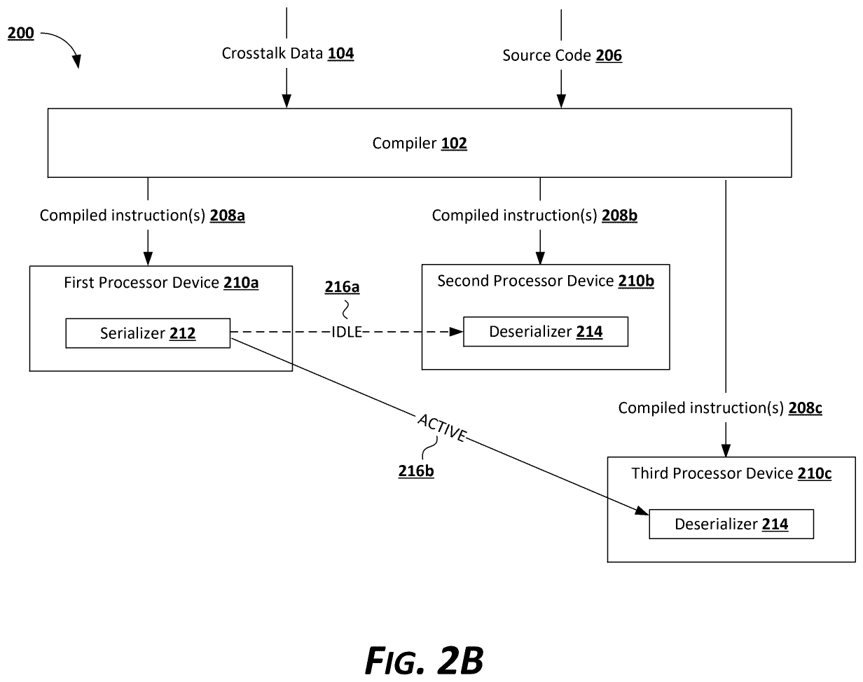

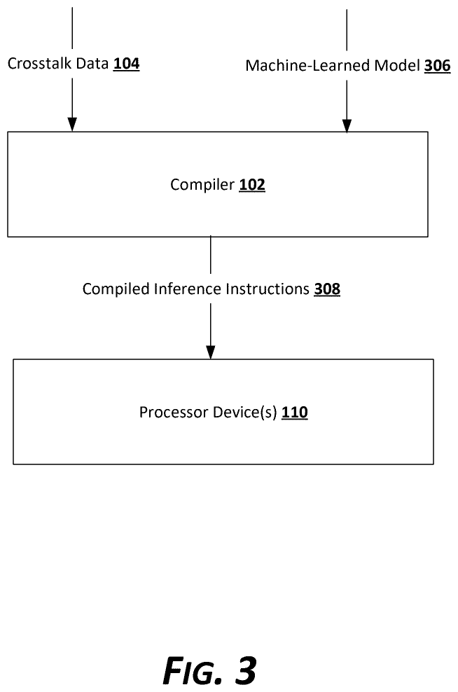

In some instances, a data transmission schedule 108 can include data indicative of a timing of one or more data transfer operations. For example, in some instances, a data transmission schedule 108 can include, for each respective data transfer operation of a plurality of data transfer operations, data indicative of one or more of: a source location; a destination location; a data item to be transferred; a data transmission path along which the data item is to be transmitted (e.g., single-leg or multi-leg path, etc.); a timing at which a transmitting device should transmit one or more bits of data along one or more identified data transmission paths; a timing at which a receiving device should receive or process the one or more bits of data; a timing at which one or more connecting devices should connect or route the one or more bits of data; or other relevant data. In some instances, an example format for a data transmission schedule 108 can include one or more computer-executable instructions (e.g., object code, assembly code, machine code, bytecode, etc.) to cause the processor device(s) 110 to perform one or more data transmission operations according to the data transmission schedule 108, such as one or more of: a first set of instructions to cause a transmitting processor to transmit data at a first time identified by the compiler 102 in the data transmission schedule 108; a second set of instructions to cause a receiving processor to receive or process data at a second time identified by the compiler 102 in the data transmission schedule; a third set of instructions to cause one or more intermediate processors or other components (e.g., connectors, routers, etc.) to forward the data at one or more third times identified by the compiler 102 in the data transmission schedule; or other relevant data. Further details of some example systems for providing computer-executable instructions indicative of a data transmission schedule 108 are provided below with respect to FIGS. 2A-3.

In some instances, determining a data transmission schedule 108 can include one or more of: determining a timing of one or more data transfer operations based on one or more known data transmission paths for the data transfer operations; determining a data path of one or more data transfer operations based on one or more known timings; selecting, from a plurality of candidate scheduling options, a combination of data path and timing for one or more data transfer operations; or other method. For example, in some instances, determining a data transmission schedule 108 can include obtaining (e.g., receiving, retrieving, generating, etc.) source/destination data 106 indicative of a plurality of data transfer operations to be performed within a given time period; and selecting, based on crosstalk data, one or more data transmission paths for performing the data transfer operations. For example, in some instances, a compiler 102 can identify two data transfer operations scheduled to be performed simultaneously, and can select, based on crosstalk data 104, non-adjacent or low-crosstalk pairs of data transmission paths for performing the data transfer operations. In some instances, a selected path can include a non-minimal path, such as a path that may require a greater number of data transfer hops compared to a minimum number of hops for traveling between a given source device and a given destination device. For example, in some instances, a compiler 102 can determine, at compile time based on crosstalk data 104, one or more non-minimal data transmission paths for one or more data transfer operations, along with a specified timing (e.g., specified clock cycle, specified number of clock cycles between one or more prior operations and the data transfer operation(s), etc.) of the one or more data transfer operations, wherein the non-minimal data transmission paths are associated with reduced crosstalk compared to transferring data along a minimal path between the given source and destination device at the specified time.

As another example, in some instances, determining a data transmission schedule 108 can include obtaining (e.g., receiving, retrieving, generating, etc.) source/destination data 106 indicative of a plurality of data transfer operations to be performed along high-crosstalk pairs of data transmission paths; and selecting, based on crosstalk data 104, one or more times for performing one or more of the data transfer operations. For example, in some instances, a compiler 102 can identify two data transfer operations destined for adjacent data transmission paths or other high-crosstalk pair of data transmission paths; and can select, based on crosstalk data 104, two non-simultaneous times for performing the data transfer operations. In some instances, a data transmission schedule 108 can include a schedule comprising little or no simultaneous transmission along adjacent or high-crosstalk pairs of data transmission paths. Further details of some example systems for non-simultaneous transmission are provided below with respect to FIGS. 2A-B.

In some instances, determining a data transmission schedule 108 can include determining the data transmission schedule 108 based on one or more tradeoffs, such as a tradeoff between bandwidth and latency, a tradeoff between computing cost (e.g., electricity cost, processor usage, memory usage, data transmission device usage, etc.) and performance (e.g., latency, throughput, etc.), or other tradeoff. In some instances, determining a data transmission schedule 108 based on a tradeoff can include selecting based on (e.g., optimizing or nearly optimizing, etc.) a score associated with the tradeoff, such as a weighted score based on a combination of one or more values, such as a weighted sum of one or more values of interest (e.g., expected latency given an expected error rate or crosstalk rate; expected data transmission throughput or computing operation throughput given a candidate data transmission schedule 108; an expected power level required to send one or more data transmission signals given an expected crosstalk amount and an error or noise threshold; etc.).

A processor device 110 can include, for example, a device (e.g., digital circuit, etc.) configured to perform one or more computing operations, such as a central processing unit (CPU), graphics processing unit (GPU), field programmable gate array (FPGA), application-specific integrated circuit (ASIC), or other processor device. In some instances, a processor device 110 can include a processor device configured for one or more machine learning operations, such as an ASIC or FPGA configured for machine learning operations. In some instances, a processor device 110 can include a deterministic processor device configured to perform computing operations according to a program order defined by a compiler 102, such as a deterministic processor configured to perform each of a plurality of computing operations at a particular time instance (e.g., particular clock cycle, etc.) predetermined by the compiler 102 or specified by a set of compiled instructions provided to the deterministic processor device. In some instances, a deterministic processor can include a processor device that lacks one or more nondeterministic optimizations, such as branch prediction, speculative execution, tiered cache hierarchy, cache prefetching, or other nondeterministic or speculative operation. Further details of some example processor devices, such as example deterministic processor devices, are provided below with respect to FIGS. 2-3 and 6.

FIG. 2A depicts a block diagram of an example first time step of an example data transmission operation according to example implementations of aspects of the present disclosure. FIG. 2B depicts a block diagram of an example second time step of the data transmission operation of FIG. 2A according to example implementations of aspects of the present disclosure. A computing system 200 can include a plurality of processor devices 210a, b, c. In some instances, the computing system 200 can have one or more high-crosstalk pairs of communication channels, such as a pair of adjacent communication channels 216a, 216b that may be located in close proximity at the first processor device 210a (e.g., on the same edge of the processor device 210a, etc.).

A compiler 102 can obtain crosstalk data 104 and source code 206 data indicative of a set of computing operations to be performed. Based at least in part on the crosstalk data 104 and source code 206, the compiler 102 can generate one or more sets of compiled instructions 208a, b, c to be performed by one or more processor devices 210a, b, c. The compiled instructions 208a, b, c can include data indicative of a timing of one or more data transfer operations (e.g., send operations, receive operations, etc.) to be performed by a processor device 210a, b, c that executes the instructions. In some instances, the sets of compiled instructions 208a, b, c can cause the processor device(s) 210a, b, c to perform the data transfer operations according to a timing that prevents one or more high-crosstalk pairs of communication channels of the computing system 200 from being simultaneously active at one or more time steps. For example, FIG. 2A depicts a first communication channel 216a of a high-crosstalk pair 216a, 216b being active at a first time step and a second communication channel 216b of the high-crosstalk pair 216a, 216b being idle at the first time step. Continuing the example, FIG. 2B depicts the first communication channel 216a being idle at a second time step and the second communication channel 216b being active at the second time step. In this manner, for instance, a compiler 102 can prevent the adjacent communication channels 216a, 216b from being active simultaneously, and crosstalk can be reduced.

In some instances, the processor device(s) 210 can communicate using a serializer 212-deserializer 214 (SerDes) interface, wherein a sending processor device 210a can serialize a set of data to be transmitted, and a receiving processor device 210b, c can receive the set of data in serial form and can deserialize it to obtain data in a parallel format. Other implementations are possible.

A computing system 200 can include, for example, one or more computing devices configured to perform various computing operations, such as data transmission operations. In some instances, a computing system 200 can include a plurality of computing devices. In some instances, each computing device of the computing system 200 can have one processor device 210 or multiple processor devices 210.

In some instances, source code 206 can be, comprise, be comprised by, or otherwise share one or more properties with source/destination data 106. For example, in some instances, source code 206 can have any property described herein with respect to source/destination data 106, and vice versa.

In some instances, source code 206 can include source code in a computer programming language, such as Python, C, Java, Rust, or the like. In some instances, source code 206 can include source code associated with one or more machine learning operations, such as PyTorch source code, Keras source code, TensorFlow source code, or other machine learning source code. Further details of an example system for generating compiled instructions based on machine learning data are provided below with respect to FIG. 3.

In some instances, compiled instruction(s) 208 can be, comprise, be comprised by, or otherwise share one or more properties with a data transmission schedule 108. For example, in some instances, compiled instruction(s) 208 can have any property described herein with respect to data transmission schedule 108, and vice versa. In some instances, compiled instruction(s) 208 can include some or all of a set of instructions to perform one or more computing operations identified in the source code 206, such as one or more data transmission instructions to cause the processor devices 210 to transfer data according to a data transmission schedule 108; and one or more other instructions, such as instructions for performing arithmetic operations (e.g., multiplication, addition, matrix multiplication, etc.), memory operations (e.g., operand retrieval, etc.), or other instructions. In some instances, compiled instruction(s) 208 can include data indicative of a program order in which the compiled instruction(s) 208a, b, c are to be executed. In some instances, compiled instruction(s) 208 can include data indicative of a timing for executing the one or more instructions, such as data indicative of a clock cycle on which to perform one or more of the compiled instruction(s) 208; data indicative of a number of clock cycles (e.g., zero, one, two, etc.) for a processor device 210a, b, c to wait (e.g., pause, delay, sleep, offset, etc.) before executing one or more instructions 208 (e.g., number of clock cycles after executing an earlier instruction 208, etc.); instruction(s) 208 to cause transmitted data and one or more instruction(s) 208 for performing operations on the transmitted data to intersect at a functional unit of a processor device 210a, b, c at a time instant (e.g., clock cycle, etc.) defined by the compiler 102; or other timing data. In some instances, generating the compiled instruction(s) 208 can include performing, by the compiler 102 at compile time, one or more of:

compile-time partitioning of a set of operations associated with the source code 206 and allocating each of a plurality of partitions to each of a plurality of processor devices 210; compile-time load balancing or other compile-time routing to define one or more data transmission paths over which a first data item (e.g., tensor of machine-learned model parameter values, etc.) should be transmitted; or other compiler 102 operations. In some instances, compile-time load balancing can include distributing a data item to be transferred across one or more data transmission paths, such as one or more non-minimal data transmission paths. Further details of some example systems for compile-time load balancing are provided below with respect to FIG. 7.

In some instances, a first, second, or third processor device 210a, b, c can be, comprise, be comprised by, or otherwise share one or more properties with a processor device 110. For example, in some instances, a first, second, or third processor device 210a, b, c can have any property described herein with respect to a processor device 110, and vice versa. In some instances, a first processor device 210a can be part of the same computing device or a different computing device compared to one or more of the second and third processor device 210 b, c.

A serializer 212 can be or include one or more software, firmware, or hardware components configured to convert parallel data from a parallel data input (e.g., bus, etc.) into serial data for transmission via a serial data transmission interface. A deserializer 214 can be or include one or more software, firmware, or hardware components configured to convert a serial data input (e.g., serial data received from a serial data transmission interface, etc.) into corresponding parallel data in a parallel format.

In some instances, a serializer 212 can include a Parallel Input Serial Output (PISO) component associated with a serializer/deserializer interface circuit (SerDes). For example, in some instances, a serializer 212 can include a shift register configured to receive one or more parallel inputs at a first clock rate (sometimes referred to as a parallel clock rate), and shift through each parallel input to generate a plurality of serial outputs (e.g., a plurality of single-bit serial outputs) at a second clock rate higher than the first clock rate. In some instances, a deserializer 214 can include a Serial Input Parallel Output (SIPO) component of a SerDes. For example, in some instances, a deserializer 214 can include a fast data storage element (e.g., register, buffer, etc.) configured to temporarily store a plurality of serial inputs (e.g., at the second clock rate, etc.) and output the plurality of serial inputs as a parallel output (e.g., at the first clock rate). In some instances, a SerDes can include a parallel clock SerDes, an embedded clock SerDes, a bit interleaved SerDes, an 8-bit/10-bit SerDes, or other SerDes type.

In some instances, a SerDes can be configured to include or not include additional data in the serial data stream, such as clock data, error correction data, or other data. In some instances, a deserializer 214 can include or be associated with a clock data recovery component. For example, in some instances, a serializer 212 can encode a clock signal into a bit stream, such as by interleaving one or more clock signals with one or more data bits, and a deserializer 214 can decode the clock signal from the bit stream. In some instances, a serializer 212 and deserializer 214 can be configured to perform or not perform one or more operations to prevent or reduce a rate of transmission error, such as differential signaling to reduce signal degradation; scrambling data at the serializer 212 and unscrambling the data (e.g., inverting or reversing the scrambling operation performed by the serializer 212, etc.) at the deserializer 214 to increase data recoverability of lost bits; or other operations. For example, in some instances, a data pattern can be scrambled such that bits that are adjacent to each other within a bit stream may be nonadjacent or unrelated to each other within the parallel data being transferred, thereby increasing a recoverability of consecutive bits lost to burst loss. In some instances, a serializer 212 and deserializer 214 can be configured to perform high-speed data transfer, such as data transfer at rates greater than or equal to than 10 gigabytes (GB) per second (e.g., greater than or equal to 20 GB/s, 40 GB/s, 80 GB/s, etc.). In some instances, compiled instructions 208 can include serializer-deserializer instructions to cause a first processor device 210a to provide data to a serializer 212; to cause a second or third processor device 210b, c to process data received from a deserializer 214; to cause a serializer 212 or deserializer 214 or corresponding processor device 210 to perform one or more serialization or deserialization operations; or the like.

A communication channel 216 can include, for example, any device or component for transmitting data signals (e.g., between processor devices 210), such as a communication channel comprising one or more of: one or more signal traces, one or more optical fibers, one or more wires, one or more cables (e.g., optical cables, coaxial cables, etc.), one or more devices (e.g., routing devices, connectors, processor devices 210, switches, patch panels, registers such as stream registers, etc.) configured to send, receive, or route data along a data transmission path; or other device or component for transmitting data signals. In some instances, a communication channel can include a channel configured to transmit various kinds of communication signals, such as optical signals, electrical pulses, electromagnetic signals (e.g., microwave signals, radiofrequency signals, etc.), or other communication signal type.

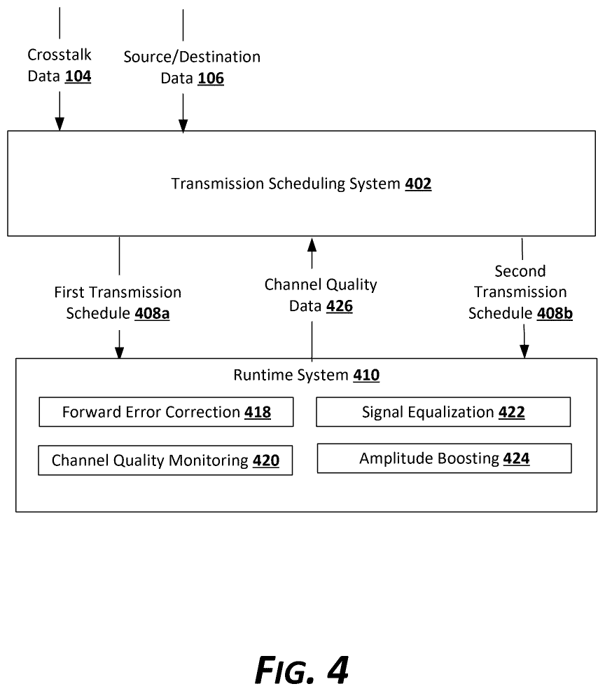

FIGS. 2A and 2B depict different time steps (e.g., different SerDes clock cycles, different processor clock cycles, etc.) having non-simultaneous transmission along adjacent data transmission paths 216a, 216b. In some instances, a first time step in which a first transmission path 216a is active can be consecutive or not consecutive with one or more time steps in which a second transmission path 216b is active. In some instances, a compiler 102 can provide a time buffer between time step(s) in which a first transmission path 216a is active and time step(s) in which a second transmission path 216b is active. In some instances, a time buffer can be large or small. In some instances, a time buffer between adjacent-active-path time steps can be one clock cycle (e.g., processor clock cycle, SerDes clock cycle, etc.) or multiple clock cycles. In some instances, a compiler 102 can select a time buffer size based at least in part on crosstalk data 104 or other data, such as channel quality data indicative of an error rate over one or more transmission channels given a current or prior data transmission schedule 108. Further details of an example system for determining a revised data transmission schedule 108 based on channel quality data are provided below with respect to FIG. 4.

FIG. 3 depicts a block diagram of an example system for compiling a machine-learned model to be executed by one or more processor devices according to example implementations of aspects of the present disclosure. A compiler 102 can obtain crosstalk data 104 and machine-learned model 306 data indicative of an uncompiled machine-learned model. Based on the crosstalk data 104 and the machine-learned model 306 data, the compiler 102 can generate compiled inference instructions 308 that, when executed by one or more processor devices 110, cause the processor device(s) 110 to perform one or more machine-learned model operations (e.g., inference operations, etc.) using the machine-learned model 306.

In some instances, machine-learned model 306 data can be, comprise, be comprised by, or otherwise share one or more properties with source/destination data 106. For example, in some instances, machine-learned model 306 data can have any property described herein with respect to source/destination data 106, and vice versa.

In some instances, a machine-learned model 306 can include various kinds of machine learning architectures, such as neural network architectures. In some instances, a machine-learned model 306 can include a plurality of parameters (e.g., weights, etc.). In some instances, a machine-learned model 306 can include a plurality of layers, with each layer having one or more parameters. In some instances, a machine-learned model 306 can include one type or multiple types of machine learning layers, such as one or more of convolutional layers; attention layers; fully connected layers; recurrent layers; gated layers (e.g., gated long short-term memory layers, selective state space model layers, etc.); pooling layers (e.g., max pool, average pool, etc.); state space model layers; or other layer type. In some instances, a machine-learned model 306 can include a plurality of layers, with each layer having one or more nodes. In some instances, a node of a machine-learned model 306 can include a node configured to receive a plurality of respective input activation values; multiply (e.g., using one or more tensor multiplication operations) each respective input activation of the plurality of input activations by a corresponding parameter (e.g., weight, etc.) of a plurality of parameters associated with the node; and combine the multiplied values to generate one or more output activations. In some instances, combining a plurality of multiplied values can include summing the values and processing the sum with an activation function (e.g., nonlinear activation function such as rectified linear unit activation function, Gaussian error linear unit activation function, sigmoidal activation function, etc.).

In some instances, data indicative of a machine-learned model 306 can include one or more of source code data (e.g., PyTorch data, TensorFlow data, Keras data, etc.), parameter value data (e.g., .safetensors file comprising a plurality of parameter values associated with a machine-learned model 306, etc.), metadata indicative of a machine-learned model 306 architecture (e.g., parameter count data or other size data; data indicative of a location in which parameter value data is stored, such as filename data, memory address data, or the like; etc.), or other data indicative of a machine-learned model 306.

In some instances, data indicative of a machine-learned model 306 can include source/destination data 106 identifying specific data transfer operations, or can include data from which a compiler 102 can determine specific data transfer operations. For example, in some instances, machine-learned model 306 data can include data (e.g., model parameter data, source code data, etc.) indicative of one or more high-level computing operations to be performed to execute one or more machine-learned model 306 operations (e.g., inference operations, etc.), and a compiler 102 can perform, based on the data, one or more of: partitioning a plurality of machine-learned model 306 operations among a plurality of processor devices; identifying one or more data transfer operations (e.g., including source, destination, approximate timing such as order of operations, data to be transferred, data size, etc.) required to execute the machine-learned model 306 operations according to the partition; determining a data transmission schedule 108 for the data transfer operations; and determining compiled inference instructions 308 to cause the plurality of processor devices 110 to perform the data transfer operations according to the schedule 108.

In some instances, compiled inference instructions 308 can be, comprise, be comprised by, or otherwise share one or more properties with a data transmission schedule 108. For example, in some instances, compiled inference instructions 308 can have any property described herein with respect to data transmission schedule 108, and vice versa. In some instances, compiled inference instructions can include one or more sets of computer-executable instructions configured to be provided to one or more processor devices 110 to cause the one or more processor devices 110 to perform one or more operations for machine-learned inference using the machine-learned model 306, such as one or more data transfer operations (e.g., chip-to-chip communication of operand data such as machine-learned model 306 weight data, activation values, or other operand data; or other data transfer operations), one or more tensor operations (e.g., tensor multiplication such as matrix multiplication, etc.), one or more activation function operations, or other machine-learned inference operations.

FIG. 4 depicts a block diagram of an example system for scheduling data transmission based on channel quality data according to example implementations of aspects of the present disclosure. A transmission scheduling system 402 can provide, to a runtime system 410 based at least in part on crosstalk data 104 and source/destination data 106, a first transmission schedule 408a. The runtime system 410 can execute one or more operations according to the first transmission schedule 408a, and can collect channel quality data 426 indicative of an error rate of one or more communication channels used during operations according to the first transmission schedule 408a. The transmission scheduling system 402 can receive, from the runtime system 410, the channel quality data 426. Based at least in part on the channel quality data 426, the transmission scheduling system 402 can provide, to the runtime system 410, a second transmission schedule 408b different from the first transmission schedule 408a. In some instances, the runtime system 410 can perform one or more additional operations (e.g., error correction or error prevention operations, etc.), such as forward error correction 418, channel quality monitoring 420, signal equalization 422, or amplitude boosting 424.

In some instances, a transmission scheduling system 402 can be, comprise, be comprised by, or otherwise share one or more properties with a compiler 102. For example, in some instances, a transmission scheduling system 402 can have any property described herein with respect to a compiler 102, and vice versa.

In some instances, a runtime system 410 can be, comprise, be comprised by, or otherwise share one or more properties with one or more processor devices 110, 210, 310. For example, in some instances, a runtime system 410 can have any property described herein with respect to a processor device 110, 210, 310, and vice versa.

A forward error correction system 418 can be or include one or more software, firmware, or hardware components configured to provide forward error correction at one or more destination devices. Forward error correction can include, for example, systems or methods for correcting errors or data loss in a data transmission without requesting retransmission of lost data. For example, in some instances, forward error correction can include encoding (e.g., at a serializer 212, etc.) a data item to be sent according to an error correction code, and decoding (e.g., at a deserializer 214, etc.) received data according to the error correction code to recover the data item that was transmitted (e.g., irrespective of whether one or more bits of the transmission was lost, flipped, or the like). In some instances, an error correction code can include a code that can be used for forward error correction on data transmissions having an error rate at or below a first error rate threshold, and error detection (e.g., without forward error correction) for data transmissions having an error rate at or below a second error rate threshold. In some instances, a data transmission schedule 108 can be determined based at least in part on one or more error rate thresholds associated with a forward error correction code. For example, in some instances, compiler 102 can obtain (e.g., receive, retrieve, etc.) data indicative of an error rate threshold associated with a forward error correction code (e.g., maximum proportion of errors that the forward error correction code can correct without requesting retransmission, etc.), and the compiler 102 can determine a data transmission schedule 108 wherein each data transmission of the data transmission schedule 108 has an expected error rate that is below the threshold.

In some instances, an error correction code or one or more properties thereof can be determined based at least in part on crosstalk data or error rate data associated with a data transmission schedule 108. For example, in some instances (e.g., in instances where simultaneous transmission along a high-crosstalk pair of data transmission paths may be required to meet a latency target or throughput target, etc.), a compiler 102 can determine a data transmission schedule 108; determine that one or more data transmissions of the data transmission schedule 108 is associated with a crosstalk amount, error rate, or the like that is above an error rate threshold of a first forward error correction 418 algorithm; and can select, based on the determination, a second forward error correction 418 algorithm having a higher error tolerance (e.g., higher maximum error rate that is correctable without retransmission, etc.) compared to the first forward error correction 418 algorithm.

A channel quality monitoring system 420 can be or include one or more software, firmware, or hardware components configured to obtain (e.g., measure, collect, generate, receive, retrieve, etc.) data indicative of a channel quality of one or more communication channels of the runtime system 410. In some instances, data obtained by a channel quality monitoring system 420 can include one or more of signal-to-noise ratio data, error rate data (e.g., detection event fraction of an error correction code, etc.), retransmission rate data (e.g., rate of retransmission requests by a forward error correction system 418, etc.), sensor data, or other channel quality data 426.

A signal equalization system 422 can be or include one or more software, firmware, or hardware components configured to perform signal equalization for the runtime system 410. Signal equalization can include, for example, reversal of one or more signal impairments (e.g., frequency-dependent losses, etc.) associated with a data transmission path. An amplitude boosting system 424 can be or include one or more software, firmware, or hardware components configured to magnify an amplitude of one or more signals associated with the runtime system 410.

In some instances, transmission schedule 408 data can include or not include instructions (e.g., compiled instructions 208, forward error correction instructions, channel quality monitoring instructions, signal equalization instructions, amplitude boosting instructions, etc.) to perform one or more of forward error correction 418, channel quality monitoring 420, signal equalization 422, or amplitude boosting 424.

Channel quality data 426 can include or represent various data types. Channel quality data 426 can include one data type or multiple data types. Example data types for channel quality data 426 can include, for example, numerical data (e.g., numerical error rate data, numerical signal-to-noise ratio data, etc.) or other data type. In some instances, channel quality data 426 can include one or more of signal-to-noise ratio data, error rate data (e.g., error rate associated with errors detected by an error correction code, etc.), retransmission rate data (e.g., rate of retransmission requests by a forward error correction system 418, etc.), sensor data, or other data indicative of a channel quality of one or more communication channels 216. In some instances, channel quality data 426 can include data (e.g., measured or collected data, etc.) indicative of insertion loss, crosstalk, or other sources of noise or error. In some instances, channel quality data 426 can be, comprise, be comprised by, or otherwise share one or more properties with crosstalk data 104. For example, in some instances, channel quality data 426 can have any property described herein with respect to crosstalk data 104, and vice versa.

In some instances, adjusting a transmission schedule 408 based on channel quality data 426 can include generating the second transmission schedule 408b based on channel quality data 426 (e.g., in any manner described herein with respect to generating transmission schedules 108 based on crosstalk data 104, etc.) and providing the second transmission schedule 408b to the runtime system 410. In some instances, adjusting a transmission schedule 408 based on channel quality 426 can include selecting between a plurality of candidate transmission schedules 408 (e.g., precompiled candidate transmission schedules 408, etc.) based on the channel quality data 426 and providing the selected transmission schedule 408 to the runtime system 410.

In some instances, adjusting a transmission schedule 408 can include adjusting to decrease crosstalk or error rate; adjusting to increase throughput; or other adjustment. For example, in some instances, a transmission scheduling system 402 can determine, based on channel quality data 426, that an error rate of the runtime system 410 is above an error rate threshold, and can determine, based on the channel quality data 426, a second transmission schedule 408b having a reduced amount of simultaneous transmission between some pairs of data transmission paths; an increased time buffer between communications along some pairs of data transmission paths; or the like. As another example, in some instances, a transmission scheduling system 402 can determine, based on channel quality data 426, that an error rate of the runtime system 410 is below an error rate threshold and can determine, based on the channel quality data 426, a second transmission schedule 408b having increased throughput compared to the first transmission schedule 408a, such as a second transmission schedule 408b having a greater degree of simultaneous transmission between some pairs of data transmission paths, a smaller time buffer between communications along some pairs of data transmission paths; or the like.

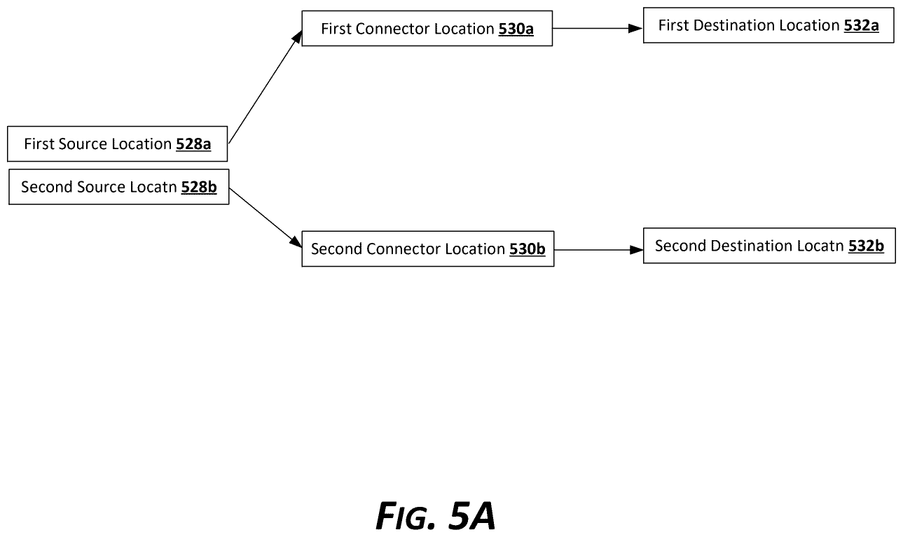

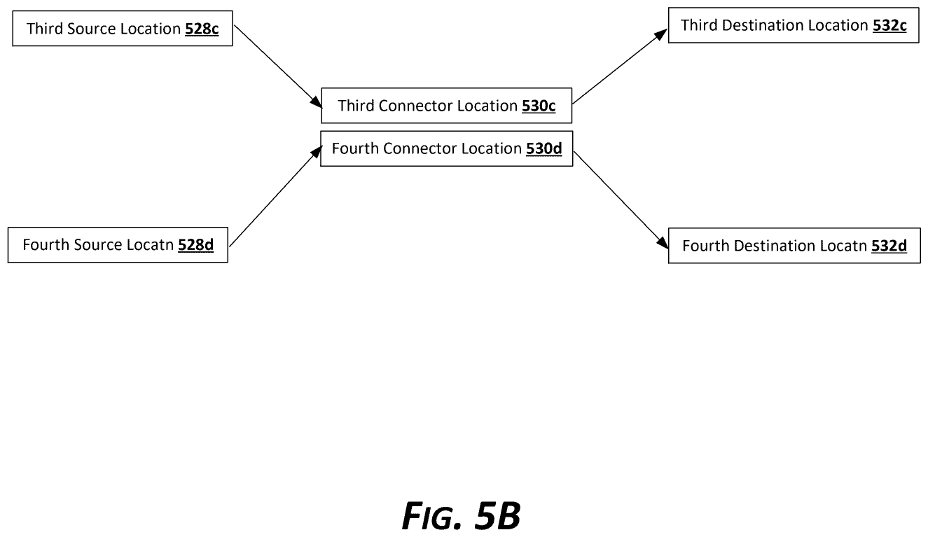

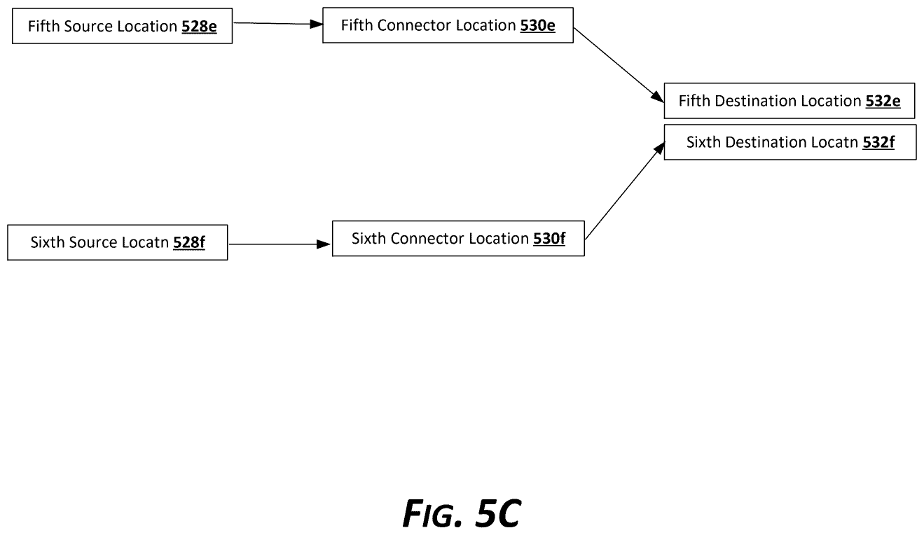

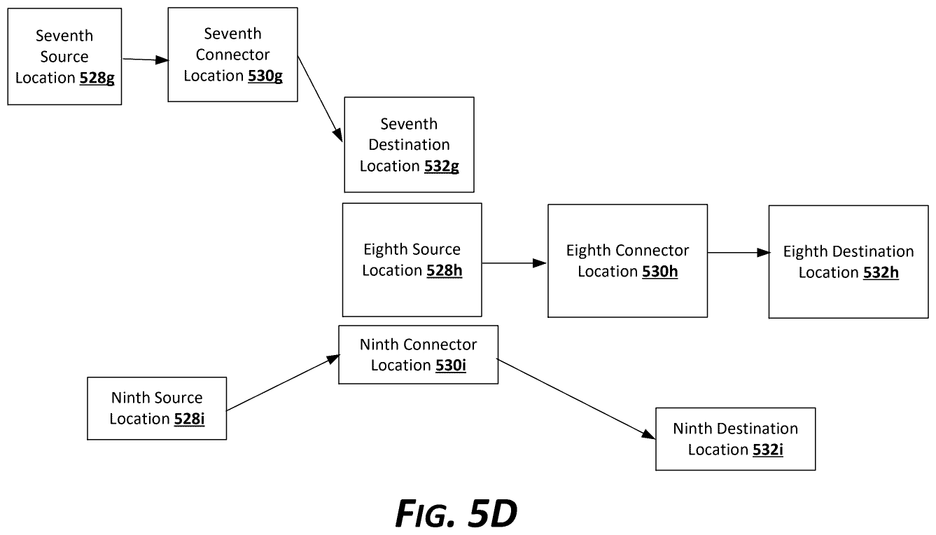

FIGS. 5A, 5B, 5C, 5D depict block diagrams of various example pairs of high-crosstalk adjacent communication channels according to example implementations of aspects of the present disclosure. For example, FIG. 5A depicts a first example pair of adjacent communication channels, wherein a first source location 528a (e.g., transmitter location, etc.) is physically proximate to a second source location 528b. In such instances, crosstalk between first and second communication channels associated with the first and second source locations 528a, b may be high (e.g., above a crosstalk threshold, etc.) irrespective of the physical distance between first and second destination locations 532a, b or between first and second connector location(s) 530a, b.

As another example, FIG. 5B depicts a second example pair of adjacent communication channels, wherein a third connector location 530c is physically proximate to a fourth connector location 530d. In such instances, crosstalk between third and fourth communication channels associated with the third and fourth connector locations 530c,d may be high irrespective of the physical distance between third and fourth destination locations 532c, d or between third and fourth source location(s) 528c, d.

As another example, FIG. 5C depicts a third example pair of adjacent communication channels, wherein a fifth destination location 530e (e.g., receiver location, etc.) is physically proximate to a sixth destination location 530f. In such instances, crosstalk between fifth and sixth communication channels associated with the fifth and sixth destination locations 532e, f may be high irrespective of the physical distance between fifth and sixth connector locations 530e, f or between fifth and sixth source location(s) 528e, f.

As another example, FIG. 5D depicts a fourth example pair of adjacent communication channels, wherein a seventh destination location 532g is physically proximate to an eighth source location 528h. In such instances, crosstalk between seventh and eighth communication channels associated with the seventh destination location 532g and eighth source location 528h may be high irrespective of the physical distance between other components of the seventh and eighth communication channels.

As another example, FIG. 5D depicts a fifth example pair of adjacent communication channels, wherein a ninth connector location 530i is physically proximate to an eighth source location 528h. In such instances, crosstalk between eighth and ninth communication channels associated with the ninth connector location 530i and eighth source location 528h may be high irrespective of the physical distance between other components of the eighth and ninth communication channels.

In some instances, a source 528, connector 530, or destination 532 can include any device or component configured to transmit data, receive data, or connect components of a data transmission path. For example, in some instances, a source 528, connector 530, or destination 532 can include a processor device 210 or component thereof; a networking device (e.g., switch, router, patch panel, etc.) or component thereof; a signal trace, cable, fiber, wire, or the like; a communication port; or other device or component for performing data transfer operations. As a non-limiting illustrative example, in some instances, a first source location 528a can be a first chip-to-chip communication port or other data transmission component at a first edge of a first processor device, and a second source location 528b can be a second chip-to-chip communication port or other data transmission component on the same first edge of the first processor device. As another non-limiting illustrative example, in some instances, a fifth destination location 532e can be a first chip-to-chip communication port or other data transmission component at a first edge of a second processor device, and a sixth destination location 532f can be a second chip-to-chip communication port or other data transmission component on the same first edge of the second processor device. As another example, a third connector location 530c can include a first chip-to-chip communication port or other data transmission component at a first edge of a connector device (e.g., router, patch panel, switch, processor device functioning as a connector, etc.) and a fourth connector location 530d can include a second chip-to-chip communication port or other data transmission component at a second edge of a connector device. Other examples are possible.

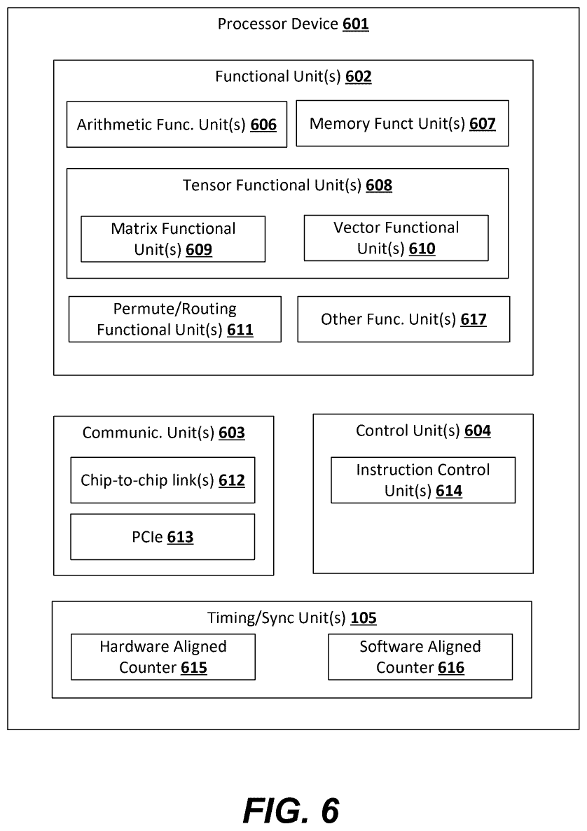

FIG. 6 is a block diagram of an example processor device 601 according to example implementations of aspects of the present disclosure. The processor device 601 can include one or more functional units 602; one or more communication units 603; one or more control units 604 (e.g., instruction control unit(s) 614, etc.); one or more timing or synchronization units 605; or other components. In some instances, functional unit(s) 602 of the processor device 601 can include one or more of: arithmetic functional unit(s) 606; memory functional unit(s) 607; tensor functional unit(s) 608 (e.g., matrix functional unit(s) 609, vector functional unit(s) 610, etc.), permute or routing functional units 611, or other functional units 617. Communication unit(s) 603 can include, for example, one or more of chip-to-chip communication link(s) 612, peripheral component interconnect express 613 components, or other communication unit(s) 603. Timing and synchronization units 605 can include, for example, one or more hardware-aligned counters 615, one or more software-aligned counters 616, or other timing or synchronization component.

A processor device 601 can include various types of processor architectures. In some instances, a processor device 601 can include a single-core or multi-core processor device 601. In some instances, a processor device 601 can include an integrated circuit located on a single die or a processor device 601 distributed over multiple dies connected together (e.g., directly connected such as via face-to-face connection, indirectly connected such as via one or more interposers, etc.). In some instances, a processor device 601 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 601 can include a deterministic processor device or a non-deterministic processor device (e.g., processor device configured to operate according to a deterministic or non-deterministic timing, etc.). In some instances, a processor device 601 can include a processor device having a plurality of dedicated special-purpose functional units, or a processor device having one or more general-purpose functional units (e.g., multi-core processor having a plurality of general-purpose processor cores, etc.). For example, in some instances, a processor device 601 can include a single-core processor device 601 having a plurality of special-purpose functional units 602 having distinct functions, such as functional units 602 having distinct instruction set architectures.

In some instances, a processor device 601 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 602 or other component of a processor device 601 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 602, communication unit(s) 603, etc.) having an instruction set architecture comprising instructions to control a timing of one or more operations of the one or more components.

In some instances, a deterministic processor device 601 can include a processor device configured to route data between functional units 602 of the processor device 601 according to a predetermined timing, predetermined routing or pathing, or both. For example, in some instances, a deterministic processor device 601 can include a processor device configured to receive compiled instructions comprising data indicative of one or more data transfers operations to be performed according to one or more predetermined routes determined by a compiler, according to one or more predetermined timing values defined by the compiler, or both. In this manner, for instance, a deterministic processor device 601 can enable a compiler to perform compile-time load balancing for a plurality of data paths, and can execute a plurality of runtime data transfers according to the compile-time load balancing. Further details of an example compiler configured to perform compile-time load balancing are provided below with respect to FIG. 7.

In some instances, a deterministic processor device 601 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 601 can lack any branch prediction components, and can be configured to execute every operation of a compiled program according to a predetermined program order. As another example, in some instances, one or more memory functional units 607 can lack a cache hierarchy or lack any non-deterministic memory component(s). For example, in some instances, one or more memory functional units 607 can be configured to operate deterministically, such as according to a predetermined timing defined by a compiler. For example, in some instances, one or more memory functional units 607 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 607; or the like. For example, in some instances, the compiler can compile a program or other executable into a set of deterministic operations that can be executed by the functional unit(s) 602 at known times specified by a deterministic schedule.

However, although a deterministic processor device 601 can lack some common sources of non-determinism, in some instances, a deterministic processor device 601 can include or interact with one or more non-deterministic components or devices without deviating from the scope of the present disclosure. As a non-limiting illustrative example, in some instances, a deterministic processor device 601 can include a PCIe 613 component configured to perform external input/output (I/O) operations, which can in some instances include input/output operations having a non-deterministic timing (e.g., I/O operations using a non-deterministic PCIe 613 device; I/O operations receiving input from non-deterministic external device(s); etc.). In some instances, a deterministic processor device 601 can interact with non-deterministic component(s) or device(s) (e.g. components or devices internal or external to the processor, etc.), while maintaining deterministic operation of the remaining components of the processor device 601 by designating one or more predetermined time windows to interact with the non-deterministic component(s) in a deterministic manner. For example, in some instances, a processor device 601 can be configured to check, at each of a plurality of predetermined times, whether one or more inputs (e.g., inference request(s), etc.) has been received via a PCIe device 613; and, if the processor device 601 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 601 can include a processor device configured for single-instruction multiple-data (SIMD) operation. For example, in some instances, a processor device 601 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 602 (e.g., adjacent functional units 602 arranged in a functional region, etc.) to cause each respective functional unit 602 of the plurality of functional units 602 to execute the instruction on one or more distinct operands provided to the respective functional unit 602 (e.g., routed to the respective functional unit 602 according to a predetermined compiler-defined routing, etc.).

In some instances, a processor device 601 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 602, a set of operations defined by the single set of instructions. For example, in some instances, a single-core processor device 601 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 602, the plurality of operations (e.g., SIMD operations wherein each operation is a multiple-data operation, etc.) on the one or more operands.

Functional unit(s) 602 can include, for example, one or more components (e.g., integrated circuit components, etc.) configured to perform operations on one or more operands (e.g., data operands, etc.). In some instances, functional unit(s) 602 can include deterministic functional units 602, such as deterministic functional units configured to perform one or more operations in a predetermined program order, according to a predetermined timing or temporal relationship, or the like. In some instances, a set of functional units 602 can include a plurality of dedicated or special-purpose functional units 602, such as distinct functional units 602 having distinct functions or sets of functions (e.g., limited or specialized function sets, etc.). In some instances, functional unit(s) 602 can include functional units configured to perform multiple operations per instruction for at least some instructions, such as single-instruction multiple-data (SIMD) functional unit(s) 602, and/or functional unit(s) 602 configured to process instruction(s) directed to multiple computing operations (e.g., multiple repetitions of a single type of operation, pipeline of multiple different operations, etc.).

In some instances, a set of dedicated functional unit(s) 602 can include distinct dedicated functional units 602 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 602 for implementing a fully connected layer of a machine-learned model can include one or more matrix functional units 609 for performing matrix multiplication between a parameter tensor (e.g., weight matrix, etc.) and a tensor (e.g., vector, etc.) of input values to the fully connected layer, and one or more vector functional units 610 for performing an activation function of the fully connected layer. As another example, in some instances, a set of dedicated functional units 602 for implementing a convolutional layer of a machine-learned model can include one or more permute/routing functional units 611 configured to perform one or more data reshaping operations corresponding to one or more convolutions (e.g., two-dimensional convolutions, one-dimensional convolutions, etc.); and one or more other functional units 602 (e.g., matrix functional unit(s) 609, vector functional unit(s) 610, etc.) for performing additional operations associated with a convolutional layer or convolutional neural network (e.g., matrix multiplication, pooling, activation functions, etc.).

In some instances, a plurality of dedicated functional units 602 can include a first functional unit 602 configured to perform a set of operations that is different (e.g., completely disjoint from or partially overlapping, etc.) from a second set of operations associated with a second functional unit 602. In some instances, a plurality of special-purpose or dedicated functional units 602 can have a plurality of distinct instruction set architectures, such as limited or special-purpose instruction set architectures each supporting a limited or special-purpose set of operations. As a non-limiting illustrative example, in some instances, a set of dedicated functional units 602 can include one or more of: a matrix functional unit 609 configured to perform a first set of matrix operations (e.g., matrix multiplication operations, etc.); a vector functional unit 610 configured to perform a set of vector operations different from the matrix operations (e.g., activation function operations such as rectified linear unit (ReLU), sigmoidal, softmax, or other activation function operations; normalization operations; etc.); a permute/routing functional unit 611 configured to perform one or more data routing, data permutation, or data reshaping functions (e.g., tensor permutation or reshaping, etc.) different from the matrix operation(s) and different from the vector operation(s); or other dedicated functional unit(s) 602. Other examples are possible.

In some instances, functional unit(s) 602 can include functional units organized into functional regions of a processor die, such as compact functional regions configured to facilitate low-latency propagation of instructions or operands within a functional unit 602 or between adjacent functional units 602. As a non-limiting illustrative example, in some instances, one or more functional units 602 can be organized into functional slices along a first axis of a processor die, thereby enabling low-latency propagation of one or more instructions along the axis, low-latency propagation of operand data along a second axis, or the like.

In some instances, functional unit(s) 602 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 602 or functional regions of a processor device 601 for performing a sequentially first operation in a computational pipeline can be geographically close to one or more functional units 602 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 602 can include functional units configured to perform multiple operations per instruction for at least some instructions, such as single-instruction multiple-data (SIMD) functional unit(s) 602 or functional units 602 configured to operate without necessarily receiving explicit instructions for each operation. For example, functional unit(s) 602 configured to operate without necessarily receiving explicit instructions for each operation can include one or more of: functional unit(s) 602 configured to receive intermittent instructions and perform multiple operations per instruction (e.g., repeated single operation, pipeline of multiple different operations, etc.); functional unit(s) 602 configured to operate without instructions according to a default operation; or the like. In this manner, for instance, an amount of communication required to provide instructions to the functional units 602 can be reduced, and operation of the processor device 601 can in some instances be simplified compared to some alternative implementations.

For example, in some instances, a SIMD functional unit 602 can include a tensor functional unit 608 configured to execute an instruction on a plurality of numerical values, such as a vector or matrix of numerical values. For example, in some instances, a tensor functional unit 608 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, etc.). In some instances, a tensor functional unit 608 can be configured to process some or all of a plurality of values simultaneously, or to execute a single-instruction multiple-data instruction according to a staggered timing.

As another example, in some instances, a functional unit 602 configured to operate based on intermittent instructions can include a functional unit 602 configured to repeat one or more operations, such as a functional unit 602 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 602 can include a functional unit 602 configured to receive and execute one or more repetition instructions (e.g., having an instruction set architecture comprising one or more repetition instructions, etc.). A repetition instruction can include, for example, an instruction to cause the functional unit 602 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 602 location, memory location, data path location, etc.) associated with a repeated operation, or other offset parameter.

As another example, in some instances, a functional unit 602 can include a functional unit 602 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 602 can include a pipelined hardware architecture (e.g., systolic array pipelined hardware, deterministic streaming hardware, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 602 can include a geographically compact architecture, wherein a plurality of components for performing a multi-operation instruction can be adjacent or otherwise close together on a processor die.

An arithmetic functional unit 606 can include, for example, one or more functional units 602 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 606 can be a tensor functional unit 608 or component thereof, or have one or more properties described below with respect to tensor functional unit(s) 608.

A memory functional unit 607 can include, for example, one or more functional units 602 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 607 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

In some instances, one or more memory functional units 607 can be configured to share a global address space accessible to a plurality of functional units 602. For example, in some instances, a global address space can include all memory locations available to the processor device 601 (e.g., including any external memory modules, etc.), such that any functional unit 602 of the processor device 601 can obtain (e.g., receive at a predetermined time defined by the compiler, such as without requiring the functional unit 602 to output any request for the data obtained). In some instances, a set of memory functional unit(s) 607 can include, or a processor device 601 can have access to, one or more internal (e.g., on-chip) memory functional units 607; one or more external (e.g., off-chip, near-compute, etc.) memory units; or both.

A tensor processing unit 608 can include, for example, a functional unit 602 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 608 can include a matrix functional unit 609; a vector functional unit 610; or another functional unit.

A matrix processing unit 609 can include, for example, a functional unit 602 configured to perform one or more operations on a matrix (e.g., two-dimensional matrix, flattened matrix, etc.) of operands (e.g., numerical values such as floating-point values, etc.). In some instances, a matrix processing unit 609 can include a functional unit 602 configured to perform matrix multiplication or other matrix operations.

A vector processing unit 610 can include, for example, a functional unit 602 configured to perform one or more operations on a vector (e.g., one-dimensional vector, flattened tensor, etc.) of operands (e.g., floating-point numerical values, etc.). In some instances, a vector processing unit 610 can include a functional unit 602 configured to perform one or more of: one or more activation function operations (e.g., sigmoidal or logistic activation function, linear unit activation function such as rectified linear unit (ReLU), softmax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 611 can include, for example, a functional unit 602 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 607; a tensor, matrix, or vector functional unit 608, 609, 610; or a permute/routing functional unit 611 can be or include a deterministic functional unit 602 configured to execute instruction(s) at a predetermined time defined by a compiler; a single-instruction multiple-operation functional unit 602 configured to perform a plurality of operations based on one instruction; or have any other property described herein with respect to functional unit(s) 602.

Communication units 603 can include various components for performing communication operations (e.g., input, output, etc.) between the processor device 601 and other devices (e.g., processor devices, computing devices, external memory devices, etc.) or components, or within the processor device 601. In some instances, communication units 603 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 601 can include a plurality of deterministic chip-to-chip communication links 612 configured to communicate with other deterministic processor devices 601 (e.g., using deterministic communication operations having a predetermined timing, communication path, or other property), along with one or more PCIe components 613 configured to interact with one or more non-deterministic components. In some instances, communication units 603 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 601 such as routers, repeaters, switches, panels, or the like); or other components configured to facilitate one or more communication operations.

Chip-to-chip communication units 612 can include, for example, any device or component for communicating with another processor device (e.g., processor device 601, etc.), such as one or more serializer-deserializer units, one or more communication channels (e.g., signal lines, etc.), one or more connection components (e.g., ports, pins, connection pads, etc.), or the like. In some instances, a processor 601 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 601. In some instances, chip-to-chip communication units 612 can include units configured to communicate with processor devices that are geographically close to or far away from the processor device 601 (e.g., in a same or different compute node as the processor device 601; in a same or different rack; etc.). In some instances, chip-to-chip communication units 612 can include connections to a plurality of distinct chips, a plurality of connections to a single chip, or both. In some instances, chip-to-chip communication units 612 can include chip-to-chip communication units 612 associated with one or more bidirectional communication channels, one or more unidirectional communication channels, or both. In some instances, chip-to-chip communication units 612 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 605 can be used to provide synchronization for one or more processor devices 601 to facilitate deterministic-timing communication between chips.

A peripheral component interconnect express (PCIe) component 613 can include, for example, a communication device configured to facilitate communication between a processor device 601 and one or more other devices (e.g., computing devices; processor devices; data storage devices; auxiliary devices; etc.). In some instances, a PCIe unit 613 can include a communication system conforming to one or more PCIe communication standards (e.g., PCIe 6.0, PCIe 7.0, etc.). Although FIG. 6 depicts a PCIe unit 613, other communication units or communication standards can be used without deviating from the scope of the present disclosure. In some instances, a processor device 601 can include a deterministic processor device 601 configured to communicate non-deterministically via the PCIe unit 613 while maintaining determinism in the functional unit(s) 602 of the processor device 601 (e.g., according to methods described above).

In some instances, control unit(s) 604 can include one or more devices for controlling one or more operations of the functional unit(s) 602, such as device(s) configured to supply one or more control signals (e.g., assembly code or machine code instructions; switching signals, multiplexer selection signals, etc.) to one or more functional unit(s) 602.

In some instances, control unit(s) 604 can include one or more instruction control unit(s) 614 configured to supply computer-executable instruction(s) to one or more functional units. In some instances, an instruction control unit 614 can include a deterministic instruction control unit 614 configured to supply instruction(s) to the functional unit(s) 602 according to a predefined program order determined by the compiler; supply instruction(s) at one or more predefined times (e.g., clock cycles, etc.); or the like. In some instances, an instruction control unit 614 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 602 at a second time (e.g., second time predetermined by the compiler, etc.)

In some instances, instruction(s) provided to a functional unit 602 by an instruction control unit 614 can be the same as or different from a corresponding instruction received by the instruction control unit 614. For example, in some instances, an instruction control unit 614 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 607, a compiled instruction; and providing, based on the compiled instruction, a plurality of control signals to one or more (e.g., a plurality of) functional units 602 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 614 can include hardware configured to receive an instruction comprising one or more timing parameters (e.g., delay amounts, etc.) or repetition parameters, and output control signal(s) to the functional unit(s) 602 to cause the functional units to perform operations according to the timing or repetition parameters (e.g., at a predetermined clock cycle defined by a compiler, etc.). In some instances, the instruction control unit 614 can control a timing or a number of repetitions of the functional unit(s) 602 by sending control signals comprising timing or repetition data, or by sending raw control signals at a specific time or plurality of times configured to cause the functional unit(s) 602 to perform operations according to one or more timing or repetition parameters.

In some instances, timing and synchronization units 605 can include various components configured to perform synchronization operations, such as operations to track or communicate time data (e.g., current clock cycle data, etc.) to one or more functional units 602 or other components of a processor device 601. In some instances, timing and synchronization units 605 can include one or more of: one or more hardware-aligned counters 615, one or more software-aligned counters 616, or other timing or synchronization component.

Hardware aligned counters 615 may be used to establish a time base for electronic circuitry in each system, such as a clock, for example. Additionally, each system may include software aligned counters 616. Software aligned counters 616 may be synchronized, for example, based on one or more computer-executable instructions (e.g., compiled instructions determined by a compiler, etc.). Hardware aligned counters 615 and software aligned counters 616 may be implemented as digital counter circuits, for example, on each integrated circuit (e.g., each processor device 601 or each die thereof, etc.). For instance, hardware aligned counters 615 may be free-running digital counters (e.g., 8-bit counters) on a processor device 601 that are synchronized periodically. Similarly, software aligned counters 616 may be digital counters (e.g., 8-bit counters) that synchronized based on timing markers triggered by one or more compiled programs.

In some instances, timing and synchronization units 605 can include one or more components 605 for internal synchronization of a plurality of components (e.g., functional units 602, etc.) of a processor device 601; one or more components 605 for external synchronization between a first processor device 601 and one or more other devices (e.g., a plurality of second processor devices 601, etc.); or both.

In some instances, synchronizing a first device (e.g., first processor device 601 or another device) with a second device (e.g., second processor device 601 or another device, etc.) can include, for example, synchronizing one or more hardware aligned counters 615 of the first processor device 601 with one or more hardware aligned counters of the second device. Synchronizing the hardware aligned counters 615 may occur periodically during the operation of each system and may occur at a higher frequency than synchronizing software counters 616, for example. Synchronizing hardware counters may include the first device sending a timing reference (e.g., timing bits representing a time stamp) to the second device over a communication channel (e.g., via chip-to-chip communication units 612, etc.). In some instances, a first system may send an 8-bit time stamp, for example. In such a scenario, a hardware counter 615 and software counter 616 of the first device may be maintained in sync locally. However, as the hardware counter 615 on a second device is synchronized to the hardware counter 616 on a second device, the software counter 616 on the second device may drift.

In some instances, software aligned counters 616 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 615 are synchronized. In some instances, these timing markers may be used to synchronize software counters 616 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 616 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 615 of a pair of devices can include sending, by a first device at a first time to, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 615 to a value of (t₀+Δt) such that the hardware aligned counters 615 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 616 can be synchronized in a manner similar to synchronization of hardware aligned counters 615. For example, in some instances, a software aligned counter 615 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t₀+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 601 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 7 is a block diagram of an example system for compiling a machine-learned model according to example implementations of aspects of the present disclosure. A compiler 734 can obtain (e.g., receive, retrieve, etc.) data indicative of a machine-learned model 746. The compiler 734, can generate, based on the data indicative of the machine-learned model 746, one or more compiled inference instructions 747 configured to cause one or more processor devices 701 to perform one or more operations (e.g., inference operations, etc.) using the machine-learned model 746. The compiler 734 can provide the compiled inference instructions 747 to the processor device(s) 701, and the processor device(s) 701 can execute the compiled inference instructions 747 based at least in part on one or more inputs 748a to generate one or more outputs 748b (e.g., machine-learned inference outputs generated using the machine-learned model 746, etc.).

In some instances, a processor device 701 can be, comprise, be comprised by, or otherwise share one or more properties with a processor device 601. For example, in some instances, a processor device 701 can have any property described herein with respect to a processor device 601, and vice versa.

In some instances, a compiler 734 can include a compiler configured to generate compiled inference instructions for one or more deterministic processor devices 701. For example, in some instances, a compiler 734 can include a compiler configured to control a timing of one or more (e.g., all, etc.) operations of one or more processor devices 701 to perform inference using the machine-learned model 746. In some instances, a compiler 734 can obtain (e.g., receive, retrieve from memory or storage, etc.) hardware knowledge indicative of various known properties of one or more compilation target processor devices 701, such as data indicative of a number, type, and location of each of a plurality of components (e.g., functional unit(s) 602, communication links 603, etc.) of the target processor device(s) 701; data indicative of an amount of time (e.g., number of clock cycles, etc.) that one or more operations may take to complete; or other timing data. In some instances, data indicative of an amount of time an operation may take can include, for example, data indicative of a number of clock cycles a functional unit 602 may take to perform a functional operation; data indicative of a transit time (e.g., number of clock cycles, etc.) for an operand data item to be transmitted from a first component (e.g., functional unit 602, communication unit 603, etc.) to a second component or from a first processor device 701 to a second processor device 701; data indicative of a transit time for instruction data to be transmitted from an instruction control unit 614 to a functional unit 602; or other timing data.

In some instances, a compiler 734 can be configured to schedule, based on the timing data, a plurality of operations (e.g., data transfer operations, functional unit 602 operations, instruction transfer operations, etc.) to cause one or more operands to intersect with one or more instructions at a functional unit 602 for executing the instructions on the operand(s) at a predetermined time instant (e.g., absolute or relative clock cycle value, etc.) selected by the compiler 734. In some instances, a compiler 734 can be configured to identify one or more data dependencies (e.g., operations that may receive, as input, an output of a previous operation, etc.) or other prerequisites to one or more operations; and deterministically schedule, based on timing data, a dependent operation at a time when all dependencies of the dependent operation will be satisfied. In some instances, a compiler 734 can control a timing of various operations of various processor 701 components (e.g., functional units 602, communication units 603, control unit(s) 604, etc.) in various ways, such as by controlling an order of operations; using one or more delay instructions to cause a processor 701 to remain idle until a predetermined time for performing a next operation; or the like. A delay instruction can include, for example, a no-operation instruction to perform no operation for one or more clock cycles; an instruction having a delay parameter indicative of a number of clock cycles to wait before or after executing the instruction; or other delay instruction.

In some instances, scheduling one or more operations can include scheduling based at least in part on dependency data. For example, in some instances, a compiler 734 can identify one or more dependencies (e.g., prerequisite operations, required operand data, etc.) of an operation; determine a completion time at which each dependency will be satisfied; and schedule the dependent operation based on the expected completion time(s). As another example, in some instances, a compiler 734 can identify a scheduled time at which a dependent operation will be performed, and schedule a start time of one or more prerequisite operations based on the scheduled time and data indicative of a duration of each prerequisite operation. As another example, in some instances, a compiler 734 can identify a periodicity (e.g., number of clock cycles per operation or set of operations) of a set of repeated operations (e.g., repeated prerequisite operations, etc.) and schedule a related set of repeated operations (e.g., repeated dependent operations, etc.) based on the periodicity (e.g., by scheduling an amount of delay between iterations of the related set of repeated operations, etc.).

In some instances, a duration of one or more operations can include a sum of a one or more time costs (e.g., duration, latency, etc.) of the one or more operations, such as one or more of: a duration or latency of one or more functional operations (e.g., floating-point operations, memory access operations, etc.) of one or more functional units 602; a duration or latency of one or more data transfer operations transferring an output of a prerequisite operation to a functional unit 602 scheduled to perform a dependent operation; or other time cost values. In some instances, scheduling a dependent operation can include determining an expected end time of one or more prerequisite operations (e.g., start time plus duration, etc.); and providing a delay instruction to a functional unit 602 performing the dependent operation to cause the functional unit 602 to execute after any dependencies are satisfied. In some instances, scheduling a prerequisite operation can include determining a latest permissible start time of one or more prerequisite operations (e.g., dependent-operation start time minus prerequisite-operation duration, etc.); and causing the prerequisite operation to be initiated on or before the latest permissible start time. In some instances, scheduling a plurality of operations can include scheduling a plurality of prerequisite operations to cause a plurality of prerequisites to be satisfied simultaneously (e.g., such that a plurality of operands intersect at a given functional unit 602 at a time determined by the compiler 734, etc.), such as by delaying one or more of the prerequisite operations to synchronize the operations with a latest-finishing prerequisite operation, or the like.

In some instances, a compiler 734 can be configured to schedule one or more operations, or allocate one or more operations to component(s) (e.g., functional units 602, etc.) for performing the operations, based at least in part on one or more of: an expected latency, an expected level of concurrency, an expected throughput, or other expected performance measure associated with one or more allocations. For example, in some instances, a compiler 734 can perform one or more memory allocation operations to reduce a latency, increase a level of memory concurrency, or otherwise improve a performance of one or more operations. For example, in some instances, a compiler 734 can identify a plurality of operand values (e.g., machine-learned model 746 parameters, etc.) to be used concurrently (e.g., parameters belonging to the same layer or head of a machine-learned mode 746, etc.), and can allocate the plurality of operand values to a plurality of independently accessible memory banks to increase memory concurrency, reduce latency, or otherwise improve performance of a processor device 701.

In some instances, a compiler 734 can be configured to deterministically schedule a timing of one or more communication operations or data access operations, such as memory access, chip-to-chip communication operations between two or more processor devices 701, or the like. For example, in some instances, a compiler can obtain hardware knowledge indicative of a topology of a chip-to-chip communication network; obtain (e.g., receive, retrieve, generate, etc.) data indicative of one or more data transfers to be performed; and allocate one or more communication links 603 for performing the data transfer(s). In some instances, the hardware data can include timing data (e.g., any form of timing data described above, etc.), and the compiler 734 can control a timing of the data transfer(s) based on the timing data. In some instances, scheduling one or more data transfers can include compile-time routing or compile-time load balancing. For example, in some instances, a compiler 734 can determine, at compile time, an amount of data associated with a data transfer; and determine, based on the amount of data and a bandwidth of one or more communication links 603, an amount of time required to transmit the data over the communication link(s) 603. In some instances, the compiler 734 can determine, based on the timing data, a reduced-latency set of data transfer path(s) for transferring the data, and can allocate the data transfer operation to the reduced-latency path(s). For example, in some instances, the compiler 734 can determine that performing a large data transfer over a small number of minimal data transfer paths (e.g., data transfer paths with a minimal number of hops, minimal latency for a one-byte transfer, etc.) may take a long time due to low collective bandwidth of the minimal data transfer paths; and allocate, at compile time, one or more non-minimal data transfer paths to the data transfer (e.g., in addition to one or more minimal paths, etc.). In some instances, a compiler 734 can control, based on the timing data, a timing of one or more data transfer operations, such as by controlling a timing of one or more memory accesses to cause a plurality of transferred data items to arrive simultaneously or near-simultaneously (e.g., with a reduced gap between first and last data of a given data transfer or set of concurrent operands, etc.).

A machine-learned model 746 can include, for example, various kinds of machine-learned model architectures, such as architectures having one or more feedforward layers (e.g., fully connected layers, perceptron layers, etc.), attention layers, convolutional layers, recurrent layers, gating components, structured state space machine layers, or other components. In some instances, a machine-learned model 746 can include a machine-learned model configured to generate various kinds of outputs, such as classification outputs, generative outputs (e.g., generative language outputs such as natural language or computer code, generative image outputs, video outputs, audio outputs, text outputs, multimodal outputs, etc.), predictive outputs, or other output type. In some instances, a machine-learned model 746 can be configured to process various input types, such as language, numerical, text, audio, video, image, time series data, or other input type. In some instances, a machine-learned model 746 can include one or more nodes, each node comprising one or mor parametrized operations, each parametrized operation comprising one or more operators and one or more operand parameters.

In some instances, data indicative of a machine-learned model 746 can include various kinds of data, such as source code data (e.g., TensorFlow source code data, PyTorch source code data, etc.), parameter data (e.g.,.safetensors file comprising a plurality of parameter tensors, etc.), operator data, or other data indicative of a machine-learned model 746.

Operators of a parametrized operation can include, for example, arithmetic operators, matrix transformation operators, Boolean operators, and other operators which take one or more inputs and generate a single output (i.e., functions), including any operators used within a machine learning model on input data. Further examples of specific operators may include multiplication, division, convolution, projection, matrix multiplication, activation functions (e.g., softmax, ReLU, sigmoid, etc.), combination operators (e.g., elementwise addition, pooling, etc.), and so on.

In some instances, parameters of a machine-learned model 746 can include tensor(s) comprising a plurality of parameter values. Parameter values can include, for example, operands for one or more operations of the machine-learned model 746 (e.g., operations taking both parameter value(s) and input value(s) as operands, etc.). Parameter values can include, for example, operands that are trained during a training process of the machine-learned model 746.

Compiled inference instruction(s) 747 can include, for example, a set of computer-executable instructions (e.g., assembly code, machine code, object code, compiled binary, etc.) configured to cause one or more processor devices 701 to perform inference using the machine-learned model 746. In some instances, compiled inference instruction(s) 747 can include instructions in a format recognized by one or more instruction control units 614 of the processor device(s) 701; one or more functional units 602 of the processor device(s) 701; or both.

Inputs and outputs 748a, b can include, for example, various kinds of data, such as numerical data, text data, language data, image data, audio data, video data, multimodal data, or other data type. In some instances, inputs 748a can include inputs provided by a user or other entity (e.g., machine-learned agent, etc.) as part of an inference request. In some instances, outputs 748b can include outputs generated by the machine-learned model 746 based on the inputs 748a.

What is claimed is:

1. A method for compile-time scheduling of data transmission to reduce an effect of crosstalk, comprising:
determining, by a compiler executing on a computing system comprising one or more computing devices, based at least in part on crosstalk data indicative of a rate of crosstalk between a first data transmission path and a second data transmission path, a timing of a first data transmission over the first data transmission path; and
providing, by the compiler, one or more computer-readable instructions to cause one or more processor devices to initiate the first data transmission according to the timing.

2. The method of claim 1, wherein determining the timing comprises:
determining, by the compiler, that the rate of crosstalk is greater than a predetermined threshold; and
scheduling, by the compiler, the first data transmission at a time when the second data transmission path will be idle.

3. The method of claim 1, wherein the crosstalk data comprises proximity data indicative of a proximity between the first data transmission path and the second data transmission path.

4. The method of claim 3, wherein the proximity data comprises data indicative of a distance between a first location along the first data transmission path and a second location along the second data transmission path, wherein the first location is one of a first transmitter location, first receiver location, or first connector location along the first data transmission path, and wherein the second location is one of a second transmitter location, second receiver location, or second connector location along the second data transmission path.

5. The method of claim 1, wherein the crosstalk data comprises data indicative of one of more of a transmission path length of the first or second data path and a transmission power of the first data transmission or a second data transmission over the second data transmission path.

6. The method of claim 1, wherein each of the first data transmission path and the second data transmission path is a chip-to-chip communication path.

7. The method of claim 1, wherein the one or more computer-readable instructions comprise first serializer-deserializer instructions configured to cause a first processor device of the one or more processor devices to serialize and transmit first data according to the timing, and second serializer-deserializer instructions configured to cause a second processor device of the one or more processor devices to receive and deserialize the first data according to the timing.

8. The method of claim 1, wherein the one or more processor devices comprise one or more processor devices configured to execute computer-readable instructions in a program order determined by the compiler.

9. The method of claim 1, wherein the timing is a first timing, the one or more computer-readable instructions are one or more first computer-readable instructions, and further comprising:
providing, by the computing system based at least in part on channel quality data indicative of a channel quality of the first data transmission path, one or more second computer-readable instructions to cause the one or more processor devices to initiate a second data transmission over the first data transmission path according to a second timing.

10. The method of claim 9, wherein providing the one or more second computer-readable instructions comprises one or more of:
providing, by the computing system responsive to determining that the channel quality is worse than a first channel quality threshold, crosstalk-reducing instructions configured to provide a greater reduction in cross-talk compared to the one or more first computer-readable instructions; and
providing, by the computing system responsive to determining that the channel quality is better than the first or a second channel quality threshold, throughput-increasing instructions configured to provide a greater transmission throughput compared to the one or more first computer-readable instructions.

11. The method of claim 10, wherein the first channel quality threshold is determined based at least in part on a maximum proportion of errors that can be corrected by an error correction code associated with the one or more first computer-readable instructions.

12. The method of claim 1, wherein the one or more computer-readable instructions comprise one or more forward error correction instructions.

13. The method of claim 1, further comprising:
selecting, by the compiler from a plurality of candidate data transmission paths, based at least in part on the crosstalk data, a third data transmission path for sending a third data transmission; and
providing, by the compiler, one or more computer-readable instructions to cause the one or more processor devices to initiate the third data transmission along the third data transmission path.

14. The method of claim 13, wherein the third data transmission path is a non-minimal path between a source and a destination of the third data transmission.

15. A computing system comprising one or more processors and one or more non-transitory computer-readable media storing first instructions that are executable by one or more first processors to cause the computing system to perform operations, the operations comprising:
determining, at a compile time based at least in part on crosstalk data indicative of a rate of crosstalk between a first data transmission path and a second data transmission path, a timing of a first data transmission over the first data transmission path;
determining, at the compile time, one or more computer-readable instructions to cause one or more second processor devices to initiate the first data transmission according to the timing; and
providing the one or more computer-readable instructions to the one or more second processor devices.

16. The computing system of claim 15, wherein determining the timing comprises:
determining, at the compile time, that the rate of crosstalk is greater than a predetermined threshold; and
scheduling, at the compile time, the first data transmission at a time when the second data transmission path will be idle.

17. The computing system of claim 15, wherein the crosstalk data comprises proximity data indicative of a proximity between the first data transmission path and the second data transmission path.

18. The computing system of claim 15, wherein each of the first data transmission path and the second data transmission path is a chip-to-chip communication path.

19. One or more non-transitory computer-readable media storing first instructions that are executable by one or more processors to cause a computing system to perform operations, the operations comprising:
determining, by a compiler based at least in part on crosstalk data indicative of a rate of crosstalk between a first data transmission path and a second data transmission path, a timing of a first data transmission over the first data transmission path;
determining, by the compiler, one or more computer-readable instructions to cause one or more processor devices to initiate the first data transmission according to the timing; and
outputting, by the compiler, the one or more computer-readable instructions.

20. The one or more non-transitory computer-readable media of claim 19, wherein determining the timing comprises:
determining, by the compiler that the rate of crosstalk is greater than a predetermined threshold; and
scheduling, by the compiler, the first data transmission at a time when the second data transmission path will be idle.
